(19) United States
(12) Patent Application Publication
(10) Pub. No.: US 2013/0080144 A1
(43) Pub. Date: Mar. 28, 2013

(54) MACHINE TRANSLATION APPARATUS, A METHOD AND A NON-TRANSITORY COMPUTER READABLE MEDIUM THEREOF

(71) Applicant: Satoshi Kamatani, Kanagawa-ken (JP)

(72) Inventor: Satoshi Kamatani, Kanagawa-ken (JP)

(73) Assignee: KABUSHIKI KAISHA TOSHIBA, Tokyo (JP)

(21) Appl. No.: 13/411,773

(22) Filed: Mar. 5, 2012

(30) Foreign Application Priority Data
Sep. 22, 2011 (JP) 2011-207824

(51) Int. Cl. G06F 17/28

(52) U.S. Cl. 704/2

(57) ABSTRACT

According to one embodiment, an apparatus translates a source sentence of a first language into a target sentence of a second language. The apparatus includes a source sentence transfer unit, a translation unit, and a proposition transfer unit. The source sentence transfer unit is configured to extract a grammatical feature from the source sentence, and to transfer the source sentence to a source proposition not including the grammatical feature. The translation unit is configured to translate the source proposition into a target proposition of the second language. The proposition transfer unit is configured to transfer the target proposition to the target sentence, based on the grammatical feature.

### CROSS-REFERENCE TO RELATED APPLICATION

This application is based upon and claims the benefit of priority from Japanese Patent Application No. 2011-207824, filed on Sep. 22, 2011; the entire contents of which are incorporated herein by reference.

### FIELD

Embodiments described herein relate generally to a machine translation apparatus, a method and a non-transitory computer readable medium thereof.

### BACKGROUND

Recently, by progress of natural language processing technique, an apparatus for translating a source sentence of a first language into a target sentence of a second language is developed. In this apparatus, a data driven type to translate based on examples of translation pair comprising a source language sentence and a target language sentence (mutually having translation relationship), and a rule-based type to translate based on rules such as grammatical rule or translation rule, are used. Especially, these two rules are widely used for practice. The data driven type has a merit that the translated result is naturally represented, and the rule-based type has a merit that consistency of the translated sentence is high.

However, in order to process variety of source language sentences by these methods, a large number of examples of translation pair is necessary for the data driven type, and complete equipment of various rules is necessary for the rule-based type. As a result, the development cost becomes high.

### BRIEF DESCRIPTION OF THE DRAWINGS

FIG. 1 is a block diagram of a machine translation apparatus according to a first embodiment.

FIG. 2 is a hardware component of the machine translation apparatus in FIG. 1.

FIGS. 3A and 3B are one example of a source sentence and a set of analysis candidates thereof according to the first embodiment.

FIGS. 4A and 4B are one example of a morpheme dictionary according to the first embodiment.

FIG. 5 is one example of a set of translation candidates according to the first embodiment.

FIG. 6 is a flow chart of processing of the machine translation apparatus according to the first embodiment.

FIGS. 7A and 7B are one example of a translated sentence and modified representation information according to the first embodiment.

FIG. 8 is a block diagram of a machine translation apparatus according to a first modification of the first embodiment.

FIG. 9 is a block diagram of a machine translation apparatus according to a second modification of the first embodiment.

### DETAILED DESCRIPTION

According to one embodiment, an apparatus translates a source sentence of a first language into a target sentence of a second language. The apparatus includes a source sentence transfer unit, a translation unit, and a proposition transfer unit. The source sentence transfer unit is configured to extract a grammatical feature from the source sentence, and to transfer the source sentence to a source proposition not including the grammatical feature. The translation unit is configured to translate the source proposition into a target proposition of the second language. The proposition transfer unit is configured to transfer the target proposition to the target sentence, based on the grammatical feature.

Various embodiments will be described hereinafter with reference to the accompanying drawings.

### The First Embodiment

As to the first embodiment, a machine translation apparatus translates a source sentence of a first language into a target sentence of a second language. In following explanation, the first language is English, and the second language is Japanese. However, object languages thereof are not limited to these two languages.

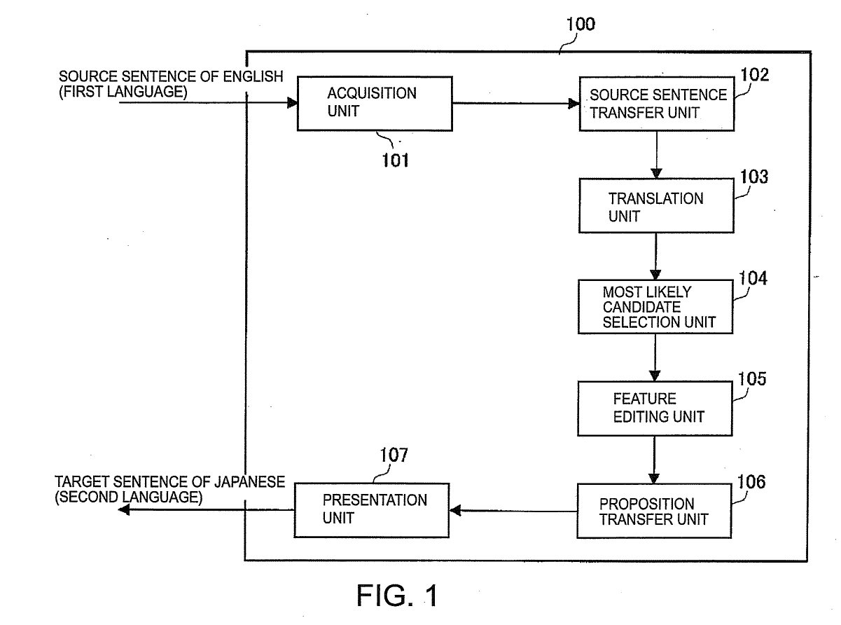

FIG. 1 is a block diagram of a machine translation apparatus 100 according to the first embodiment. As shown in FIG. 1, the machine translation apparatus 100 includes an acquisition unit 101, a source sentence transfer unit 102, a translation unit 103, a most likely candidate selection unit 104, a feature editing unit 105, a proposition transfer unit 106, and a presentation unit 107.

The acquisition unit 101 acquires a source sentence represented in English. The source sentence transfer unit 102 extracts a grammatical feature from the source sentence, and transfers the source sentence to a source proposition not including the grammatical feature. The translation unit 103 translates the source proposition into a target proposition. The most likely candidate selection unit 104 selects one target proposition having the highest score (calculated by the translation unit 103) and the grammatical feature thereof. The feature editing unit 105 edits the grammatical feature selected by the most likely candidate selection unit 104. The proposition transfer unit 106 transfers the target proposition (selected by the most likely candidate selection unit 104) to a target sentence represented in Japanese, based on the grammatical feature edited by the feature editing unit 105. The presentation unit 107 presents the target sentence of Japanese.

The grammatical feature is a subjective recognition or an utterance attitude for a proposition of a speaker in the source sentence. In the first embodiment, a tense, an aspect, a modality, or a voice, are used as the grammatical feature. Furthermore, the proposition is a sentence representing objective things not including the grammatical feature. The source proposition is a proposition of English from which the variety is excluded in comparison with the source sentence. The target proposition is a proposition of Japanese acquired by translating the proposition of English.

In the machine translation apparatus of the first embodiment, a grammatical feature is extracted from a source sentence to be translated, and the source sentence is translated into a source proposition not including the grammatical feature. Then, the source proposition is translated to a target proposition by the translation unit. In this case, the source proposition has not variety. Accordingly, a development cost of the translation unit to translate the source proposition can be lowered.

Furthermore, in the machine translation apparatus of the first embodiment, based on the grammatical feature edited, the target proposition is converted to a target sentence. As a result, the target sentence having variety of the source sentence and a user's desired representation can be generated.

(Hardware Component)

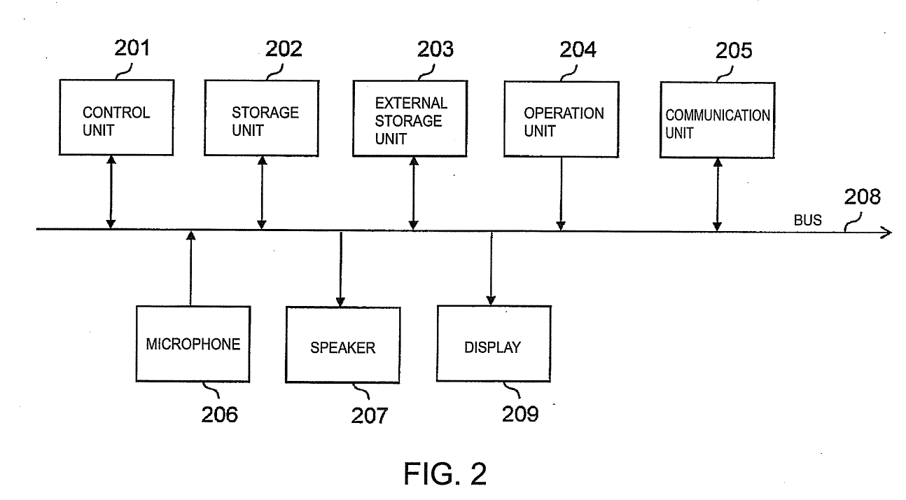

The machine translation apparatus of the first embodiment is composed with a hardware utilizing a regular computer shown in FIG. 2. A control unit 201 such as CPU (Central Processing Unit) controls all the apparatus. A storage unit 202 such as ROM (Read Only Memory) or RAM (Random Access Memory) stores various data and programs. An external storage unit 203 such as HDD (Hard Disk Drive) or CD (Compact Disk) drive device stores various data and programs. An operation unit 204 such as a keyboard or a mouse accepts an indication input from a user. A communication unit 205 controls communication with an external device. A microphone 206 acquires the user's utterance. A speaker 207 outputs a sound by reproducing a speech waveform. A display 209 displays a video. A bus connects above-mentioned units.

In such hardware component, the control unit 21 executers various programs stored in the storage unit 202 (such as ROM) or the external storage unit 203. As a result, following functions are realized.

(Input Unit)

The acquisition unit 101 acquires a source sentence of English. A user can input the source sentence via a keyboard of the operation unit 204. Furthermore, the source sentence may be acquired by recognizing the user's speech acquired via the microphone 206. Besides this, the source sentence maybe acquired by recognizing a hand-written character or from an external device connected with the communication unit 205.

(The Source Sentence Transfer Unit)

The source sentence transfer unit 102 extracts a grammatical feature from the source sentence (acquired by the acquisition unit 101), and transfers the source sentence to a source proposition not including the grammatical feature. By using morphological analysis technique, syntactic analysis technique and reference resolution technique, the source sentence transfer unit 102 analyzes the source sentence. Then, by using this analysis technique, the source sentence transfer unit 102 extracts a plurality of grammatical features from the source sentence, and transfers the source sentence to a plurality of source propositions. In this case, as the morphological analysis technique, analysis method based on concatenation cost and analysis method based on statistical language model, are used. As the syntactic analysis technique, CYK method and general LR method are used.

In the first embodiment, a tense, an aspect, a modality and a voice are extracted as a grammatical feature, and the source sentence from which the grammatical feature is excluded is set to a source proposition. In this case, in comparison with the source sentence, the source proposition has representation from which variety is excluded. As a result, a development cost of the translation unit 103 to translate the source proposition can be lowered.

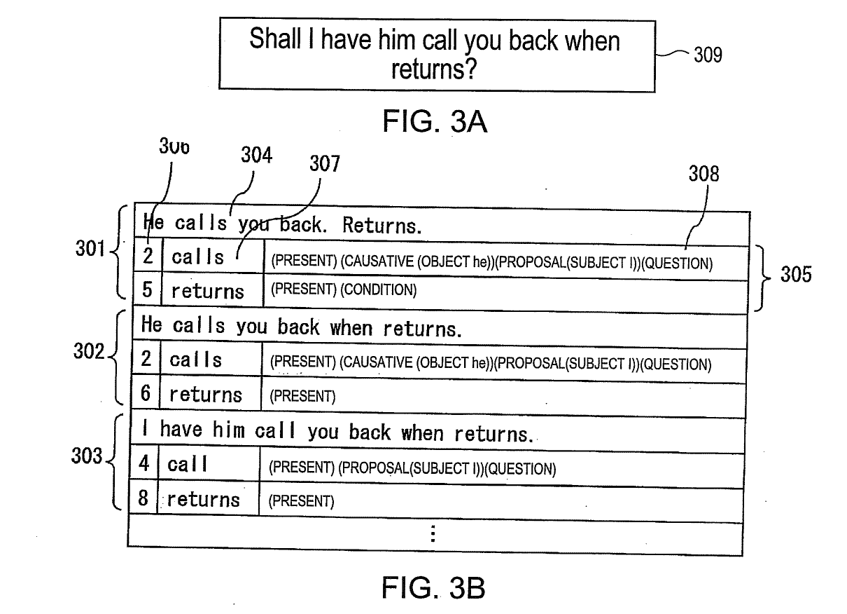

FIGS. 3A and 3B are one example a grammatical feature and a source proposition by the source sentence transfer unit 102. In the first embodiment, the source sentence transfer unit 102 outputs a plurality of combinations of a grammatical feature and information related thereto (representation information), and a source proposition not including the grammatical feature, as a set of analysis candidates. In FIGS. 3A and 3B, from the source sentence 309 “Shall I have him call you back when returns?” (FIG. 3A), three combinations 301˜303 (FIG. 3B) are generated. A combination 301 includes a source proposition 304 and representation information 305. The representation information 305 includes a grammatical feature 308, an identifier 306 to correspond the grammatical feature 308 with any morpheme of the source proposition 304, and a morpheme 307 of the source proposition identified by the identifier 306. The identifier 306 represents a position of a morpheme in the case that the identifier of the head morpheme is “1”. In this example, a grammatical feature 308 “(present) (causative(object (object he)) (proposal (subject I)) (question)” is corresponded with a morpheme 307 “calls”.

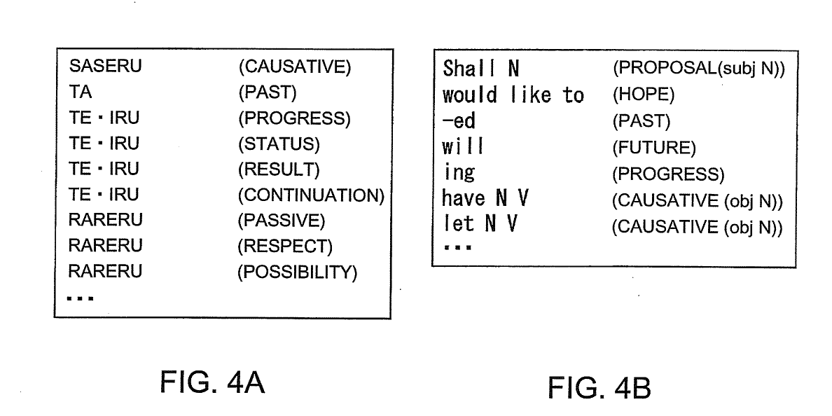

The source sentence transfer unit 102 extracts the grammatical feature based on a morpheme dictionary and syntactic dictionary shown in FIGS. 4A and 4B. For example, by referring to the dictionary of FIGS. 4A and 4B, a source sentence “KAISEKISARETA” is analyzed as “KAISEKI•SURU•RERU•TA”. From this sentence, a proposition “KAISEKISURU” and a grammatical feature “(passive) (past)” are generated. Furthermore, in a source sentence of English “Shall I have him call you back when returns?”, “Shall I” is analyzed to correspond to “Shall N”, and “have him call” is analyzed to correspond to “have N V”. Accordingly, grammatical features “(proposal (subject I))” and “(causative (object he))” are respectively extracted. Moreover, N represents a noun, and V represents a verb.

(The Translation Unit)

The translation unit 103 translates a source proposition of English to a target proposition of Japanese. As translation processing by the translation unit 103, the transfer method (translation method of general rule-based type), the example-based method or the statistic-based method (translation method of date driven type), are used.

In the first embodiment, the translation unit 103 executes translation processing for all source propositions belonging to a set of analysis candidates (generated by the source sentence transfer unit 102), and a target proposition (translated from each source proposition) and a translation score thereof. Then, the translation unit 103 generates a translation candidate including the source proposition, the representation information, the target proposition and the translation score.

The translation score is an index representing a translation quality. In the example-based method, a similarity between input character string and an example is used. In the statistical-based method, a generation probability of translation based language model is used. In the translation method of rule-based type, a value based on syntactical likelihood or priority of the rule is used.

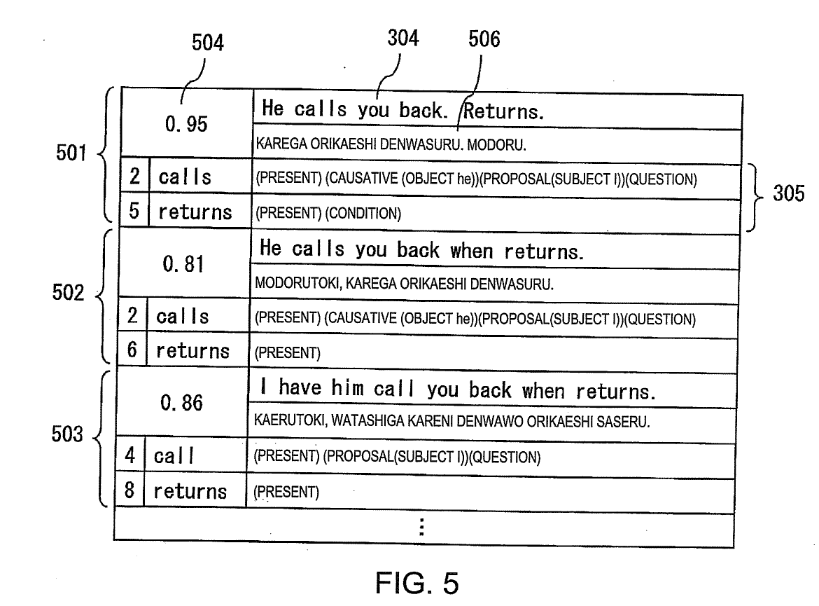

FIG. 5 is one example of a set of translation candidates outputted by the translation unit 103. In FIG. 5, three translation candidates 501˜503 are shown. A translation candidate 501 includes a translation score 504 and a target proposition 506 translated from the source proposition 304. As to each translation candidate, representation information extracted by the source sentence transfer unit 102 is added.

In the first embodiment, the translation unit 103 translates the source proposition from which variety is excluded. As a result, a development cost thereof can be lowered. As to the data driven type, a quantity of examples of translation pair can be reduced. As to the rule-based type, rules to be described can be limited to knowledge related to the source proposition.

(The Most Likely Candidate Selection Unit)

Based on the translation score calculated by the translation unit 103, from combinations of the representation information and the target proposition (belonging to the set of translation candidates), the most likely candidate selection unit 104 selects a combination having the highest translation score. The representation information and the target proposition included in the selected combination are respectively called “most likely grammatical feature” and “most likely target proposition”.

(The Feature Editing Unit)

The feature editing unit 105 edits the most likely grammatical feature. In response to a user's indication from the operation unit 204, the feature editing unit 105 can add, delete and change the grammatical feature. The grammatical feature after editing is called “modified grammatical feature”.

In this way, the feature editing unit 105 edits the grammatical feature by the user's indication. As a result, in the proposition transfer unit 106 (explained afterwards), a target sentence unified by the user's desired style is generated.

(The Proposition Transfer Unit)

Based on the modified grammatical feature, the proposition transfer unit 106 transfers the most likely target proposition to a target sentence of Japanese. In the first embodiment, the proposition transfer unit 106 transfers based on a grammar for generation. Besides this, a language generation method widely used may be applied. Detail of the proposition transfer unit 106 is explained afterwards.

In this way, based on the modified grammatical feature, the proposition transfer unit 106 transfers the most likely target proposition to a target sentence of Japanese. As a result, a target sentence having variety of the source sentence and the user's desired representation can be generated.

(The Output Unit)

The presentation unit 107 presents the target sentence of Japanese (generated by the proposition transfer unit 106). The presentation unit 107 can display the target sentence via the display 209 or outputs via a printer connected with the communication unit 205. Besides this, the target sentence may be converted to a speech wave by speech-synthesis and reproduced from the speaker 207.

(Flow Chart)

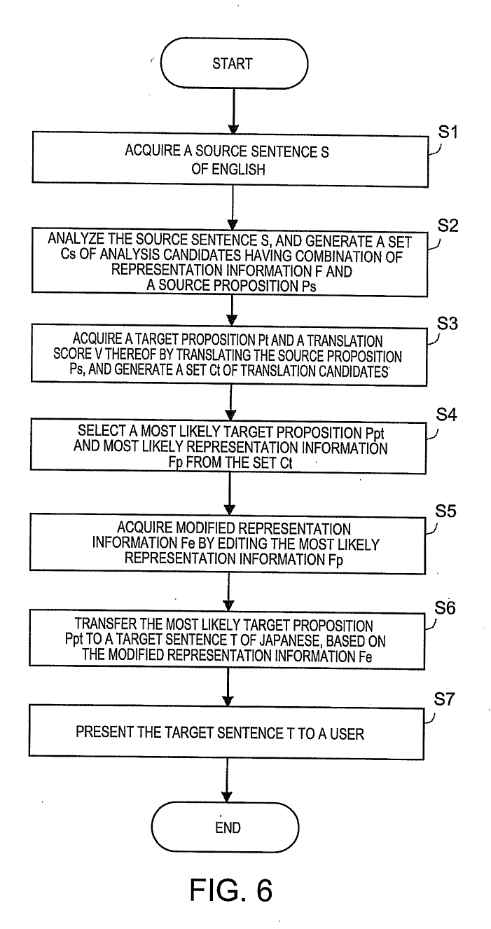

By referring to a flow chart of FIG. 6, processing of the machine translation apparatus of the first embodiment is explained. First, at Si, the acquisition unit 101 acquires a source sentence S of English. In the first embodiment, the source sentence 309 “Shall I have him call you back when returns?” in FIG. 3 is acquired.

At 82, the source sentence transfer unit 102 analyzes the source sentence S, and extracts a set Cs of analysis candidates each including a combination of the representation information F and the source proposition Ps. In FIG. 3, 301˜303 represent each analysis candidate of the set Cs.

In this case, in comparison with the source sentence S, the source proposition Ps has representation from which variety is excluded. As a result, a development cost of the translation unit 103 to translate the source proposition can be lowered. Briefly, as to the data driven type, a quantity of examples of translation pair to be collected can be reduced. As to the rule-based type, rules to be described can be limited to knowledge related to the source proposition.

At S3, the translation unit 103 translates the source proposition Ps, and acquires a target proposition Pt and a translation score V thereof. Then, the translation unit 103 generates a set Ct of translation candidates each including a combination of the source proposition Ps, the representation information F, the target proposition Pt and the translation score V. In FIG. 5, 501˜503 represent each translation candidate of the set Ct.

At S4, from the set Ct of translation candidates, the most likely candidate selection unit 104 selects the target proposition Pt (having the highest translation score) and the grammatical feature F thereof as most likely target proposition Ppt and most likely representation information Fp respectively. In example of FIG. 5, the translation score 504 is 0.95 as the highest value. Accordingly, 506 is selected as the most likely target proposition Ppt, and 305 is selected as the most likely representation information Fp.

At S5, the feature editing unit 105 edits the most likely representation information Fp, and acquires modified representation information Fe. The feature editing unit 105 can edit the most likely representation information Fp based on the user's indication. Furthermore, the feature editing unit 105 may automatically set representation information previously set. For example, if the source sentence S is provided as a document, in order to unify representation of all the document, a suitable grammatical feature can be added.

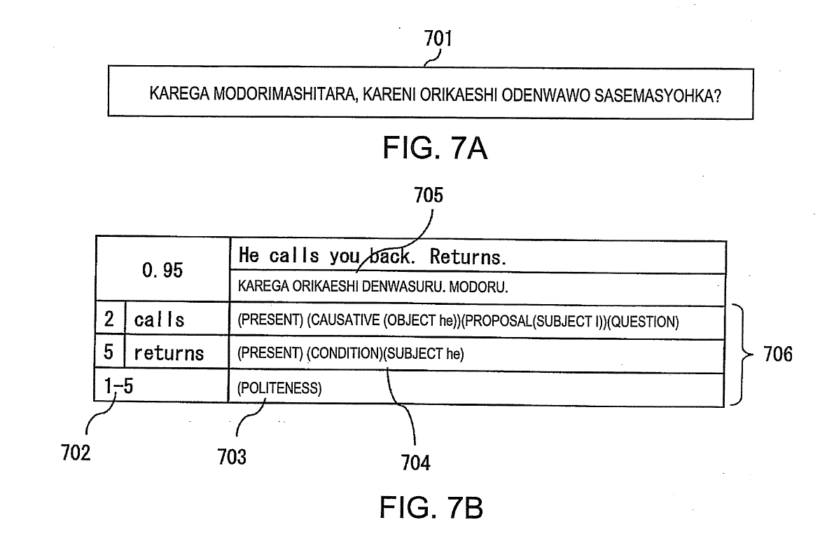

FIG. 7 is one example of the modified representation information Fe. In this example, as a new grammatical feature, a grammatical feature 703 “(politeness)” and a grammatical feature 704 “(subject he)” are added. As to the grammatical feature 703, an identifier 702 of a morpheme corresponded thereto is “1-5”. Briefly, the grammatical feature “(politeness)” affects all most likely target proposition Ppt. Furthermore, the grammatical feature 704 is corresponded to a morpheme “returns”, which represents that “he” is supplemented as “subject” of “returns”.

At S6, based on the modified grammatical feature Fe, the proposition transfer unit 106 transfers the most likely target proposition Ppt to a target sentence T of Japanese. Here, the target sentence T is a result that the source proposition Ps (generated from the source sentence S) and the modified grammatical feature Fe are entirely transferred. In FIG. 7, based on the modified representation information Fe 706, the most likely target proposition Ppt 705 “KAREGA ORIKAESHI DENWASURU. MODORU.” is transferred to the target sentence T 701 “KAREGA MODIRIMASHITARA, KARENI ORIKAESHI ODENWA SASEMASYOHKA?”.

In the first embodiment, the proposition transfer unit 106 generates the target sentence by reverse conversion of processing of the source sentence transfer unit 102. For example, in FIG. 7, as to a second word “calls” in the source proposition “He calls you back. Returns.”, a grammatical feature “(present) (causative (object he)) (proposal (subject I)) question)” is added. Here, assume that the second word “calls” is translated into “DENWA SURU”. The proposition transfer unit 106 transfers this word into “DENWA SURU” by using the grammatical feature “(present)”, transfers “DENWA SURU” into “DENWA SASERU” by using the grammatical feature “(causative (object he))”, transfers “DENWA SASERU” into “DENWA SASEMASU” by using the grammatical feature “(proposal (subject I))”, and transfers “DENWA SASEMASU” into “DENWA SASEMASUKA” by using the grammatical feature “(question)”. Furthermore, by using the grammatical feature “(politeness)” added to all the source proposition, “DENWA SASEMASYOHKA?” is generated. Furthermore, as to a fifth word “Returns” in the source proposition, “KAREGA MODORIMASHITARA” is generated in the same way.

In order for the proposition transfer unit 106 to generate a target sentence, except for above-mentioned method, a natural language generation technique using a generation grammar or a statistical natural language generation technique using Markov Model may be used.

Last, at 87, the presentation unit 107 presents the target sentence T (generated at S6) to the user.

(Modification)

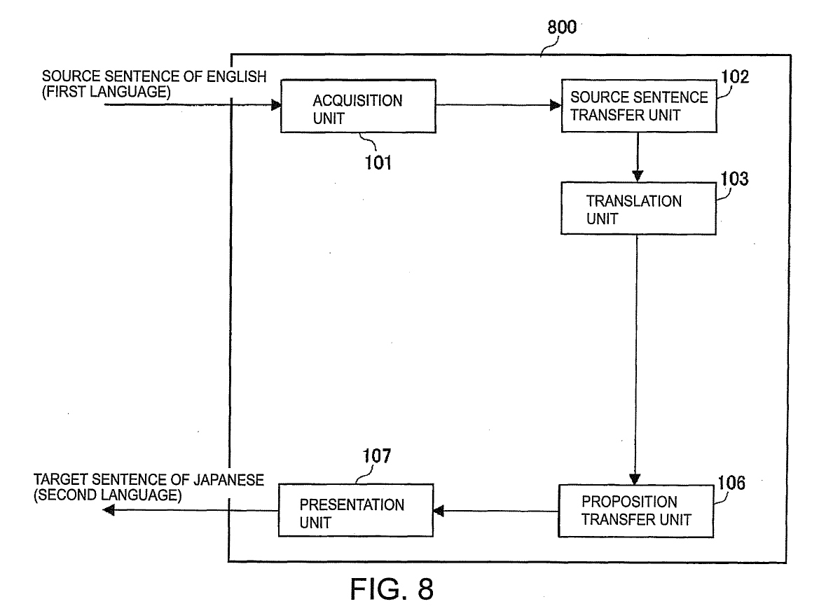

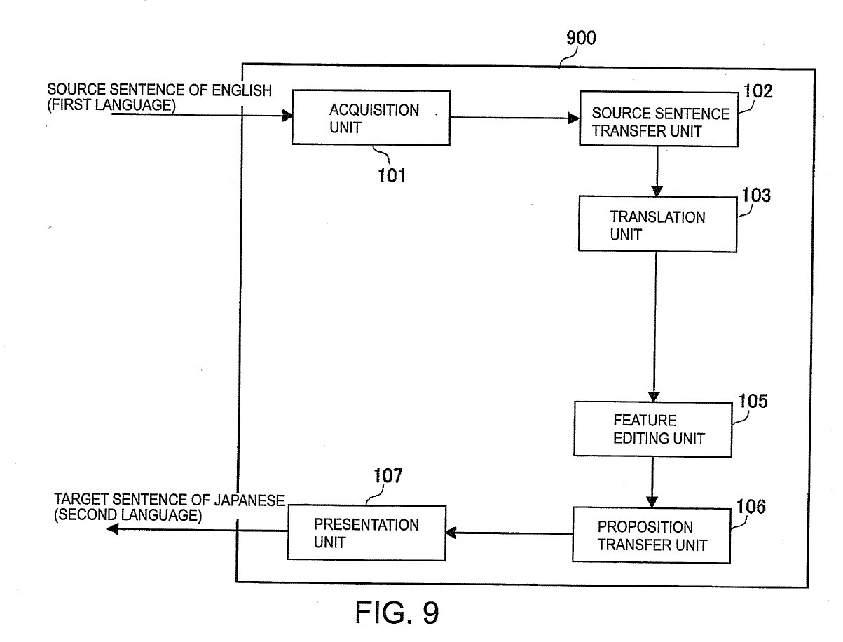

The machine translation apparatus of the first embodiment can be modified to component shown in FIG. 8 or FIG. 9.

The machine translation apparatus 800 of FIG. 8 does not include the most likely candidate selection unit 104 and the feature editing unit 105. This feature is different from the machine translation apparatus 100 of FIG. 1. In the machine translation apparatus 800, the translation unit 103 outputs one translation candidate having the highest translation score. As a result, same processing as the machine translation apparatus 100 can be executed.

The machine translation apparatus 900 of FIG. 9 does not include the most likely candidate selection unit 104. This feature is different from the machine translation apparatus 100 of FIG. 1. In the machine translation apparatus 900, the translation unit 103 outputs one translation candidate having the highest translation score. Alternatively, the feature editing unit 105 edits representation information of one translation candidate having the highest translation score. As a result, same processing as the machine translation apparatus 100 can be executed.

(Effect)

As to the machine translation apparatus of the first embodiment, a grammatical feature is extracted from a source sentence to be translated, and the source sentence is transferred to a source proposition not including the grammatical feature. Then, the source proposition is translated into a target proposition by the translation unit. In this case, variety is already excluded from the source proposition. Accordingly, a development cost of the translation unit to translate the source proposition can be lowered.

Furthermore, as to the machine translation apparatus of the first embodiment, based on the grammatical feature edited, the target proposition is transferred to a target sentence. As a result, the target sentence having variety of the source sentence and a user's desired representation can be generated.

In the disclosed embodiments, the processing can be performed by a computer program stored in a computer-readable medium.

In the embodiments, the computer readable medium may be, for example, a magnetic disk, a flexible disk, a hard disk, an optical disk (e.g., CD-ROM, CD-R, DVD), an optical magnetic disk (e.g., MD). However, any computer readable medium, which is configured to store a computer program for causing a computer to perform the processing described above, may be used.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for translating a source sentence of a first language into a target sentence of a second language, comprising:
a source sentence transfer unit configured to extract a grammatical feature from the source sentence, and to transfer the source sentence to a source proposition not including the grammatical feature;
a translation unit configured to translate the source proposition into a target proposition of the second language; and
a proposition transfer unit configured to transfer the target proposition to the target sentence, based on the grammatical feature.

2. The apparatus according to claim 1, further comprising:
a feature editing unit configured to edit the grammatical feature;
wherein the proposition transfer unit transfers the target proposition to the target sentence, based on the edited grammatical feature.

3. The apparatus according to claim 1, wherein
the source sentence transfer unit transfers the source sentence to a plurality of source propositions,
the translation unit translates the plurality of source propositions into a plurality of target propositions of the second language, and
the proposition transfer unit selects a target proposition of which translation score calculated by the translation unit is highest among the plurality of target propositions, and transfers the selected target proposition to the target sentence.

4. The apparatus according to claim 1, wherein
the grammatical feature is a subjective recognition or an utterance attitude for a proposition of a speaker in the source sentence.

5. The apparatus according to claim 4, wherein
the grammatical feature is a tense, an aspect, a modality, or a voice.

6. A method for translating a source sentence of a first language into a target sentence of a second language, comprising:
extracting a grammatical feature from the source sentence;
transferring the source sentence to a source proposition not including the grammatical feature;
translating the source proposition into a target proposition of the second language; and
transferring the target proposition to the target sentence, based on the grammatical feature.

7. A non-transitory computer readable medium for causing a computer to perform a method for translating a source sentence of a first language into a target sentence of a second language, the method comprising:
extracting a grammatical feature from the source sentence;
transferring the source sentence to a source proposition not including the grammatical feature;
translating the source proposition into a target proposition of the second language; and
transferring the target proposition to the target sentence, based on the grammatical feature.
